(19) United States
(12) Patent Application Publication
(10) Pub. No.: US 2020/0324351 A1
(43) Pub. Date: Oct. 15, 2020

(54) Methods and Apparatuses for Cutting Soffit

(71) Applicant: Vito Ribaudo, Matawan, NJ (US)

(72) Inventor: Vito Ribaudo, Matawan, NJ (US)

(21) Appl. No.: 16/383,726

(22) Filed: Apr. 15, 2019

(51) Int. Cl. B23D 47/02; B23D 45/16; B23D 45/00; B23D 47/04

(52) U.S. Cl. CPC B23D 47/02; B23D 47/04; B23D 45/003; B23D 45/16

(57) ABSTRACT

An adjustable guide for cutting building material with a circular saw is provided. The guide includes a base having two section with a space therebetween defining a path of travel for a circular saw blade. The guide includes a rail system having two rails, where each rail is attached to a base section. The space between the base and the rail system provides a channel for receiving one or more stacked layers of building material simultaneously.

### FIELD OF THE APPLICATION

The present application relates generally to methods and apparatuses for cutting building materials, and more particularly an adjustable guide for cutting soffit.

### BACKGROUND OF THE APPLICATION

Devices for cutting soffit in the prior art are either common hand shears or snips, which are very slow to use and thus not well suited for large projects, and do not allow for very accurate straight cuts. Contractors may use a miter saw to cut soffit more accurately, but such devices are not intended for such tasks and are therefore limited, including being unable to cut soffit material in bulk and also with regard to the material's length and width cutting capacity. Accordingly, there is a need for a soffit cutting guide that is much more versatile than the devices currently used for cutting soffit in the art.

### SUMMARY OF THE APPLICATION

The present application addresses and resolves or otherwise ameliorates one or more of the disadvantages or limitations of the previously known devices for cutting soffit.

In at least one embodiment, an adjustable guide for cutting building material with a circular saw is provided which enables a contractor or homeowner to cut building material quickly, efficiently, and/or in bulk using a common circular saw. In this embodiment, the adjustable guide includes a set of rails that the circular saw rides on and that guide the circular saw to cut building material at the desired dimensions. The distance between the rails is preferably adjustable to accommodate various width circular saws. The guide further includes a bed where building material is placed and to which the rails are attached for cutting the building material to the desired length. The bed preferably includes a plurality of fences and stops as discussed herein for repeatable and relatively precise cuts. The adjustable soffit guide can preferably accommodate any width soffit, including from 6 inches to 24 inches. The guide may be configured for the rails to swivel or otherwise rotate about an axis perpendicular to the bed for angled cuts. The cutting guide is preferably constructed to be portable and can be mounted on any flat surface, including a saw horse, a cutting table, or the ground.

In another embodiment, an adjustable guide for cutting building material with a circular saw is provided. The guide includes a base that includes a first base section and a second base section. The base sections have a space therebetween defining a path of travel for a circular saw blade. The guide includes a rail system that includes a first rail and a second rail. The first rail is attached to the first base section and the second rail is attached to the second base section. The space between the base and the rail system defines a channel configured to receive one or more stacked layers of building material simultaneously.

In another embodiment, the base sections are configured to be adjustably coupled to each other such that the space between the base sections and the space between the rails are adjustable to accommodate a circular saw base plate of various widths.

In another embodiment, the rail system is attached to the base via two left-to-right fences. Each left-to-right fence is attached to and extends along a proximal and distal end of the base.

In another embodiment, the rails are configured to allow a base plate of a circular saw to be seated on, and glide along and between the rails with a lateral movement of less than or equal to 0.25 inches.

In another embodiment, the first and second rails are parallel and a distance between the rails is adjustable to accommodate a circular saw base of various widths.

In another embodiment, at least one of the first and the second rails is releasably coupled at at least one end thereof to at least one left-to-right fence. At least one of the first and the second rails is operable to be recoupled between a first location and a second location on at least one of the left-to-right fences.

In another embodiment, the first rail is releasably coupled at a first end thereof to a first left-to-right fence and is pivotally coupled at a second end of the first rail to a second left-to-right fence. The second rail is configured to be releasably coupled at each end to each of the first and second left-to-right fences, such that the first and second rails are parallel to each other when recoupled.

In another embodiment, the guide includes a sliding rail coupled to the distal ends of the first and the second rails that slides relative to the distal left-to-right fence. The sliding rail includes a handle thereon configured to releasably lock the position of the coupled first and second rails.

In another embodiment, at least one of the first and the second rails includes one or more engagement means at intervals along the length of the first and the second rail for positive engagement of at least one of the first and the second rails.

In another embodiment, the guide includes an adjustable building material length stop adjustably coupled to the base and parallel to the rail system and the circular saw blade path of travel.

In another embodiment, the guide includes one or more width fixing fences adjustably coupled to the base.

In another embodiment, the base includes a ruler to measure a length of building material to be cut. The ruler is configured to allow a zero mark of the ruler to be adjustable relative to a reference point on the base.

In another embodiment, an adjustable guide for cutting building material with a circular saw is provided. The guide includes a base that includes a first base section and a second base section. The base sections have a space therebetween defining a path of travel for a circular saw blade. The guide includes a circular plate attached to the base and configured to rotate about an axis perpendicular to the base. The guide includes a rail system that includes a first rail and a second rail. The rails are attached to the circular plate. The space between the base and the rail system defines a channel configured to receive one or more stacked layers of building material simultaneously. The guide includes two width fixing fences adjustably coupled to the base. The width fixing fences are configured to simultaneously move equidistantly toward and away from a centerline between the width fixing fences. The center of the circular plate, the centerline of the rail system, and the centerline of the width fixing fences are superimposed on each other.

In another embodiment, the rail system is attached to the circular plate via two left-to-right fences.

In another embodiment, the rails are configured to allow a base plate of a circular saw to be seated on, and glide along and between the rails with a lateral movement of less than or equal to 0.25 inches.

In another embodiment, the first and second rails are parallel and a distance between the rails is adjustable to accommodate a circular saw base of various widths.

In another embodiment, at least one of the first and the second rails is releasably coupled at at least one end thereof to at least one left-to-right fence. At least one of the first and the second rails is operable to be recoupled between a first location and a second location on at least one of the left-to-right fences.

In another embodiment, the first rail is releasably coupled at a first end thereof to a first left-to-right fence and is pivotally coupled at a second end of the first rail to a second left-to-right fence. The second rail is configured to be releasably coupled at each end to each of the first and second left-to-right fences, such that the first and second rails are parallel to each other when recoupled.

In another embodiment, the guide includes a sliding rail coupled to the distal ends of the first and the second rails that slides relative to the distal left-to-right fence. The sliding rail includes a handle thereon configured to releasably lock the position of the coupled first and second rails.

In another embodiment, at least one of the first and the second rails includes one or more engagement means at intervals along the length of the first and the second rail for positive engagement of at least one of the first and the second rails.

Furthermore, the various exemplary embodiments disclosed in the present application may readily and advantageously utilize any number and/or combination of wide variety of possible features, that each provide one or more specific beneficial/desirable characteristics, properties, functions, and/or features to the adjustable soffit cutting guide.

Other objects and features of the disclosures of the present application will become apparent from the following detailed description considered in conjunction with the accompanying drawings. It is to be understood, however, that the drawings are designed solely for purposes of illustration and not as a definition of the limits of the invention, for which reference should be made to the appended claims.

### BRIEF DESCRIPTION OF THE DRAWINGS

In the drawings, where like reference characters denote corresponding or similar elements throughout the various figures:

FIG. 1 is a front perspective view of the adjustable soffit cutting guide in accordance with an exemplary embodiment of the application.

FIG. 2 is another front perspective view of the adjustable soffit cutting guide in accordance with an exemplary embodiment of the application.

FIG. 3 is a top view of the adjustable soffit cutting guide in accordance with an exemplary embodiment of the application.

FIG. 4 is another top view of the adjustable soffit cutting guide in accordance with an exemplary embodiment of the application

### DETAILED DESCRIPTION OF PREFERRED EMBODIMENTS

In various exemplary embodiments thereof, adjustable soffit cutting devices and corresponding methods are provided that address and/or resolve one or more of the flaws and/or drawbacks of previously known devices for cutting soffit.

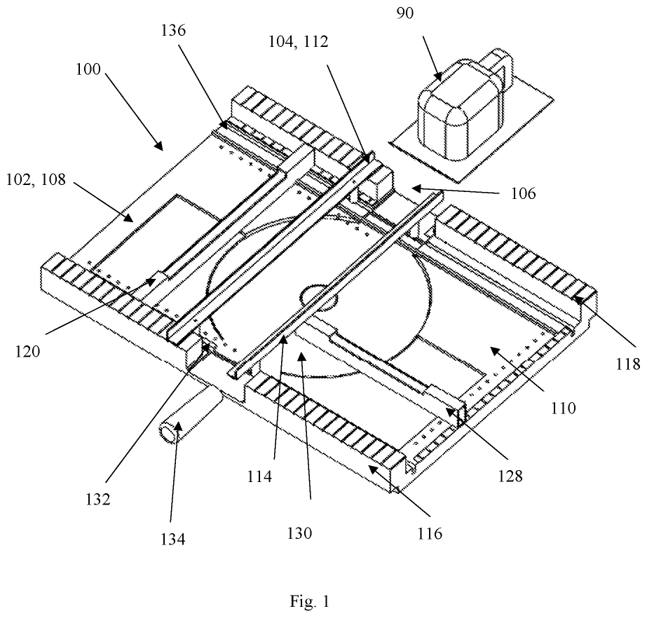

Referring now to FIGS. 1-4, exemplary embodiments for an adjustable guide for cutting soffit are shown. As can be seen, the device 100 includes a base 102 and an adjustable rail system 104 attached to the base 102.

In a preferred embodiment, the base 102, a planar structure, is bisected by a groove 106 dividing the base into two base sections 108, 110 and defining a path of travel for a circular saw blade. The groove is of sufficient width and depth to accommodate the blade of a circular saw 90 such that the blade does not contact the bottom of the groove. In a preferred embodiment, the groove is rectangular shaped, although the groove may be any shape, including u-shaped, v-shaped, or rounded. In an alternative preferred embodiment, the base 102 is divided into two separate base sections separated by a space, rather than a groove, between a first and a second base sections 108, 110 therewith defining a path of travel for the circular saw blade. In one embodiment, the rail system 104 includes a first and a second rails 112, 114 each attached to one of the base sections 108, 110. The base sections 108, 110 may be adjustably coupled to each other, for example, with a horizontal (left to right) rail system (not shown) that allows a user to adjust the space between the base sections 108, 110 and correspondingly the space between the rails 112, 114 of the rail system 104 to accommodate different width circular saws 90. The space is of sufficient width and depth to accommodate a circular saw blade such that the blade does not contact the surface on which the base is placed, i.e., a table, sawhorse, ground, etc. The two sections of the base 102, whether bisected by a groove, or separated by a space, need not be of equal size.

In a preferred embodiment, the base may be a single molded piece of material. In an alternative embodiment, the base may be composed of multiple components configured to provide for a stabilized base. The base may be stabilized by any of a number of means known to one of ordinary skill in the art. In one embodiment, the base or base sections may be composed of a flat surface mounted onto a rectangular frame with a plurality of joists or joist-like beams arranged in parallel running the length of the base. The individual components of the base, including the frame and joists, may also be bisected by the groove defining the path of travel for the circular saw blade.

The base 102 may be any of one or more solid durable materials, including but not limited to, metal, plastic, wood, or composite material, provided that the material is lightweight to facilitate portability. In a preferred embodiment, the base is made from aluminum alloy.

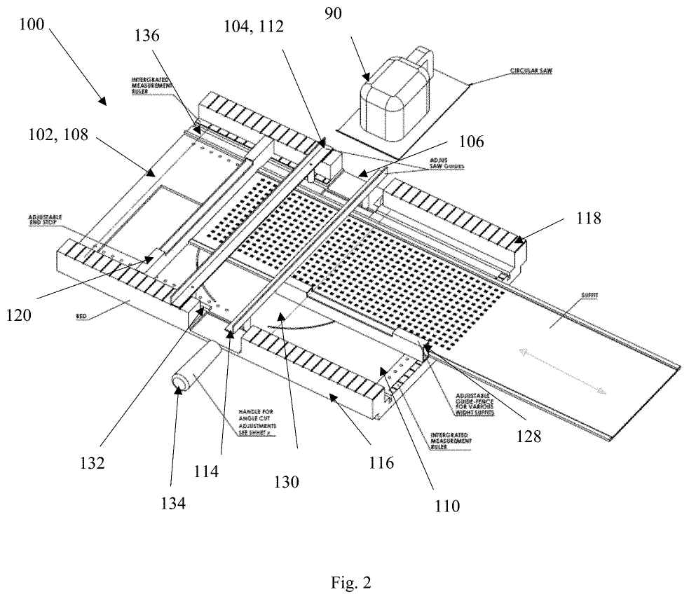

The rail system 104 according to at least one embodiment is mounted to the base 102, preferably via a pair of parallel left-to-right fences 116, 118 that extend from each proximal and distal end of the base 102. The fences 116, 118 and base 102 form a channel into which soffit is placed for cutting, as show in FIG. 2 and as discussed in greater detail below. The rail system 104 preferably includes two parallel rails 112, 114 mounted to the base 102 at opposite sides of the base 102 by a means for mounting the rails to the base. The mounting means may be any of a number of means known to one of ordinary skill in the art, including screws, nuts/bolts, pegs, etc. The rails may be attached to the base 102, the fences 116, 118, or to a circular plate 130 attached to the base 102, as discussed in greater detail below.

In a preferred embodiment, the rails 112, 114 are L-shaped aluminum angles configured in parallel to allow the base plate of a circular saw to be seated on, and glide along, the surface of, and between, the angles with minimal lateral movement, e.g., up to 0.25 inches.

The rails 112, 114 are preferably adjustable widthwise (left to right) to accommodate the dimensions of a circular saw 90 of various sizes, according to a circular saw's given base plate dimensions. The width between the rails may be made adjustable by any of a number of ways. In a preferred embodiment, this adjustability is accomplished with at least one of the rails 112, 114 releasably coupled at at least one end of the rail to a location on at least one of the left-to-right fences 116, 118 and capable of being releasably recoupled at that end to another location on the left-to-right fences 116, 118. For example, a first rail 112 may be fixed at both ends to the left-to-right fences 116, 118, while the second rail 114, may be slidingly coupled at both ends to the left-to-right fences 116, 118 (or to the base). The sliding-coupling capability may be with a T-track extending along the tops of the left-to-right fences 116, 118 and a T-nut/bolt assembly for locking the rail 114 to the fences 116, 118. In this regard, a user may release the second rail 114, adjust the spacing between it and the first rail 112 and reaffix the second rail 114 to the fences 116, 118 (or the base, as the case may be) for the cutting operation. In this embodiment, the first rail 112 is preferably orthogonal to the fences 116, 118 for 90-degree cuts of the soffit.

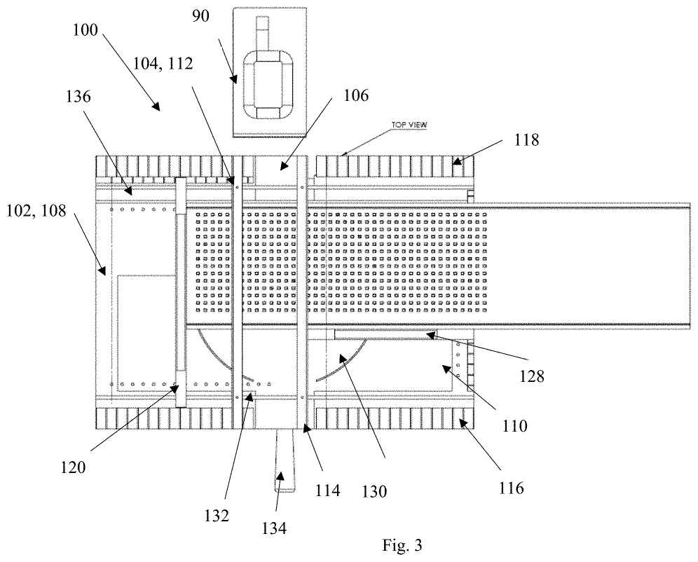

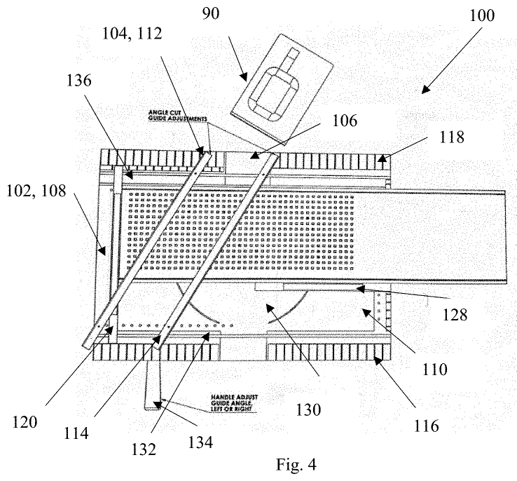

In at least one embodiment, the rail system 104 is capable of tilting or swiveling relative to the left-to-right fences 116, 118 in a plane parallel to that of the base 102 for angled cuts of the soffit. This too may be achieved in a variety of ways. In one embodiment, this adjustability for angled cuts is accomplished with both of the rails 112, 114 movable (not fixed) relative to the fences 116, 118. For example, the first rail 112 may be pivotally coupled at one end to the proximal left-to-right fence 116 and slidingly and releasably coupled at the other end at the distal left-to-right fence 118, as shown in FIG. 4. This will allow a user to release the distal end of the first rail 112 from the distal fence 118, adjust the orientation thereof relative to the fences 116, 118 to the desired angle (e.g., from 0 to 45-degrees), and reaffix the distal end of the rail 112 to the fence 118 for cutting of the soffit. In this instance, the second rail 114 will need to be adjusted to be parallel with the first rail 112, and reaffixed at both ends to the fences 116, 118 (or the base). Adjusting the rails in parallel to be parallel may be achieved in a variety of ways. In one embodiment, the base plate of a circular saw may be seated in the rails 112, 114 as they are adjusted to maintain the parallel alignment of the rails. The user may then place the soffit into the channel, align with the left-to-right fences 116, 118, and thereafter proceed with the cutting operation. The first rail 112 may have indents or other indicia representing a change in the angle every 15 degrees, for example, for positive engagement of the rail at such increments. The distal ends of the rails 112, 114 may further be coupled to a rail 132 that slides relative to the distal fence, having a handle 134 thereon that allows the user to lock and unlock the angle of the rails 112, 114, as shown in FIGS. 3-4. The handle 134 may be coupled to the rail 132 via a slot in the base 102. The left-to-right fences 116, 118 may further include rulers thereon to assist for measuring soffit cuts. In this embodiment, the pivot will be about the first rail 112 and the rulers may therefore be keyed to the pivotal axis of the first rail 112. That is, the zero mark on the ruler may be set to the first rail pivotal axis, as shown in FIG. 4. The ruler may also be adjustable to allow for the zero mark to align with the gap or space in the base, the blade travel path, or any other reference point.

The rails 112, 114 of the adjustable rail system 104 may be mounted above the planar portion of the base 102 to allow for a channel that accepts multiple layers of soffit material to be cut to be placed in the cutting guide. For example, the rails 112, 114 may be 3-4 inches above the base 102 to accommodate the maximum depth for most circular saws.

An adjustable soffit length stop 120 may be provided on the base 102 of the guide for adjustably fixing the cut length of the soffit pieces. The soffit length stop 120 is preferably coupled to the base in a sliding relationship so that it may be moved across in the left to right direction of the guide 100 and is parallel to the cutting groove 106 and rails 112, 114, when adjusted for right angle cuts. The soffit length stop 120 is adjustable to accommodate the desired length of soffit to be cut. The soffit length stop 120 may be adjustably coupled to the base 102 by any of a number of different ways. In a preferred embodiment, the stop 120 is attached to at least one track system 136 as shown in the figures, which slides relative to the base in a direction parallel to the proximal and distal fences 116, 118.

In at least one embodiment, the guide 100 includes one or more width fixing fences 128 adjustably coupled to the base 102 to accommodate the width of a soffit. The width fixing fences 128 can preferably accommodate any width soffit, including from 6 inches to 24 inches. This fence 128 is preferably able to be moved proximally and distally in a direction perpendicular to the rails system 104 (when set for right angle cuts) to secure soffit of different sizes placed therein, as shown in FIGS. 2-4. In this regard, the width fixing fence 128 runs across at least a portion of the width of the guide 100 and is perpendicular to the cutting groove 106, rail guide 104, and the soffit length stop 120. Like the soffit length stop 120, the width fixing fences 128 may be adjustably fixed by any of a number of ways to the base, such as using a track system. In one embodiment, a pair of width fixing fences may be provided that are adjustably coupled to each other on a rack and pinion system, which when operated causes the fences to be moved toward and away from each other at the same time. In one embodiment, the two sides of the base between which soffit material will be fed may also have a raised edge against which the soffit material can be inserted into the guide.

As discussed earlier, in at least one embodiment, the rails 112, 114 may be attached to a circular plate 130 attached to the base 102 and configured to swivel or otherwise rotate about an axis perpendicular to the base for angled cuts. In this embodiment, the width fixing fences 128 may move to maintain the center of the soffit in line with the center of the circular plate 130. In this instance, rails 112, 114 attached to the circular plate 130 for adjusting the angle of the cut will be configured so that the centerline of the rail system 104 is superimposed over the center of the circular plate 130, and the centerline of the soffit passes through these overlapping centers. The structures and mechanisms described herein to adjust the rails may also be mounted to the circular plate 130. The circular plate 130 may be flush with the base 102, recessed within the base to allow the soffit material to enter the guide. In another embodiment, the base 102 may be mounted upon the circular plate 130 such that the circular plate is stationery and the base may swivel or otherwise rotate about an axis perpendicular to the circular plate base for angled cuts.

A ruler is provided against or on the distal and/or proximal fences 116, 118 of the base for measuring soffit length. The ruler measures the distance from the edge of the blade path to the soffit length stop 120. A second may be provided for measuring soffit width.

In operation, a circular saw 90 is placed on the adjustable saw guide 104, with the width of the rails 112, 114 adjusted as needed to accommodate the width of base plate of the saw used. The saw is removed, the soffit length stop 120 adjusted to the length of soffit pieces desired to be cut, and the soffit width stop 128 is adjusted for the width of the soffit provided. A length one or more pieces of soffit material may then be stacked together and slid into the cutting space of the soffit cutting guide. The face of the soffit material is placed squarely against the soffit length stop, the base plate of the saw is returned to the adjustable saw guide, and the saw is activated and glided along the rails 112, 114 to cut the soffit material in a single pass. The cut soffit material is removed from the guide, allowing another length of soffit is slid into the cutting space to be cut.

Thus, while there have been shown and described and pointed out fundamental novel features of the soffit cutting guide as applied to preferred embodiments thereof, it will be understood that various omissions and substitutions and changes in the form and details of the soffit cutting guide illustrated, and in its operation, may be made by those skilled in the art without departing from the spirit of the disclosure. For example, it is expressly intended that all combinations of those elements and/or method steps which perform substantially the same function in substantially the same way to achieve the same results are within the scope of the application. It is the intention, therefore, to be limited only as indicated by the scope of the claims appended hereto.

What is claimed is:

1. An adjustable guide for cutting building material with a circular saw comprising:
a base comprising a first base section and a second base section, wherein the base sections have a space therebetween defining a path of travel for a circular saw blade; and
a rail system comprising a first rail and a second rail, wherein the first rail is attached to the first base section and the second rail is attached to the second base section, wherein the space between the base and the rail system defines a channel configured to receive one or more stacked layers of building material simultaneously.

2. The guide of claim 1, wherein the base sections are configured to be adjustably coupled to each other such that the space between the base sections and the space between the rails are adjustable to accommodate a circular saw base plate of various widths.

3. The guide of claim 1, wherein the rail system is attached to the base via two left-to-right fences, wherein each left-to-right fence is attached to and extends along a proximal and distal end of the base.

4. The guide of claim 1, wherein the rails are configured to allow a base plate of a circular saw to be seated on, and glide along and between the rails with a lateral movement of less than or equal to 0.25 inches.

5. The guide of claim 1, wherein the first and second rails are parallel and a distance between the rails is adjustable to accommodate a circular saw base of various widths.

6. The guide of claim 1, wherein at least one of the first and the second rails is releasably coupled at at least one end thereof to at least one left-to-right fence, the at least one of the first and the second rails therewith operable to be recoupled between a first location and a second location on the at least one of the left-to-right fences.

7. The guide of claim 6, wherein the first rail is releasably coupled at a first end thereof to a first left-to-right fence and is pivotally coupled at a second end of the first rail to a second left-to-right fence, and wherein the second rail is configured to be releasably coupled at each end to the each of the first and second left-to-right fences, such that the first and second rails are parallel to each other when recoupled.

8. The guide of claim 7, further comprising a sliding rail coupled to the distal ends of the first and the second rails that slides relative to the distal left-to-right fence, the sliding rail comprising a handle thereon configured to releasably lock the position of the coupled first and second rails.

9. The guide of claim 7, wherein at least one of the first and the second rails further comprises one or more engagement means at intervals along the length of the first and the second rail for positive engagement of the at least one of the first and the second rails.

10. The guide of claim 1, further comprising an adjustable building material length stop adjustably coupled to the base and parallel to the rail system and the circular saw blade path of travel.

11. The guide of claim 1, further comprising one or more width fixing fences adjustably coupled to the base.

12. The guide of claim 1, wherein the base further comprises a ruler to measure a length of building material to be cut, wherein the ruler is configured to allow a zero mark of the ruler to be adjustable relative to a reference point on the base.

13. An adjustable guide for cutting building material with a circular saw comprising:
a base comprising a first base section and a second base section, wherein the base sections have a space therebetween defining a path of travel for a circular saw blade;
a circular plate attached to the base and configured to rotate about an axis perpendicular to the base;
a rail system comprising a first rail and a second rail, wherein the rails are attached to the circular plate, wherein the space between the base and the rail system defines a channel configured to receive one or more stacked layers of building material simultaneously; and
two width fixing fences adjustably coupled to the base, wherein the width fixing fences are configured to simultaneously move equidistantly toward and away from a centerline between the width fixing fences, wherein the center of the circular plate, the centerline of the rail system, and the centerline of the width fixing fences are superimposed on each other.

14. The guide of claim 13, wherein the rail system is attached to the circular plate via two left-to-right fences.

15. The guide of claim 13, wherein the rails are configured to allow a base plate of a circular saw to be seated on, and glide along and between the rails with a lateral movement of less than or equal to 0.25 inches.

16. The guide of claim 13, wherein the first and second rails are parallel and a distance between the rails is adjustable to accommodate a circular saw base of various widths.

17. The guide of claim 13, wherein at least one of the first and the second rails is releasably coupled at at least one end thereof to at least one left-to-right fence, the at least one of the first and the second rails therewith operable to be recoupled between a first location and a second location on the at least one of the left-to-right fences.

18. The guide of claim 17, wherein the first rail is releasably coupled at a first end thereof to a first left-to-right fence and is pivotally coupled at a second end of the first rail to a second left-to-right fence, and wherein the second rail is configured to be releasably coupled at each end to the each of the first and second left-to-right fences, such that the first and second rails are parallel to each other when recoupled.

19. The guide of claim 18, further comprising a sliding rail coupled to the distal ends of the first and the second rails that slides relative to the distal left-to-right fence, the sliding rail comprising a handle thereon configured to releasably lock the position of the coupled first and second rails.

20. The guide of claim 18, wherein at least one of the first and the second rails further comprises one or more engagement means at intervals along the length of the first and the second rail for positive engagement of the at least one of the first and the second rails.
